(19) United States
(12) Patent Application Publication
(10) Pub. No.: US 2016/0358489 A1
(43) Pub. Date: Dec. 8, 2016

(54) DYNAMIC LEARNING SUPPLEMENTATION WITH INTELLIGENT DELIVERY OF APPROPRIATE CONTENT

(71) Applicant: International Business Machines Corporation, Armonk, NY (US)

(72) Inventors: Alexander J. CANTER, Rochester, MN (US); Adam T. CLARK, Mantorville, MN (US); John S. MYSAK, Rochester, MN (US); Aspen L. PAYTON, Byron, MN (US); John E. PETRI, St. Charles, MN (US); Michael D. PFEIFER, Rochester, MN (US)

(21) Appl. No.: 14/815,569

(22) Filed: Jul. 31, 2015

Related U.S. Application Data
(63) Continuation of application No. 14/729,993, filed on Jun. 3, 2015.

(51) Int. Cl. G09B 5/02; G09B 7/00

(52) U.S. Cl. CPC G09B 5/02; G09B 7/00

(57) ABSTRACT

Method to perform an operation comprising identifying, in a corpus comprising a plurality of items of content, a subset of the plurality of items of content having a concept matching a concept in a learning environment, wherein each item of content comprises a set of attributes, computing an assistance score for each item of content in the subset based on the set of attributes of the respective item of content in the subset and a set of attributes of a user in the learning environment, and upon determining that a first item of content, of the subset of items of content, has as an assistance score greater than the assistance scores of the other items in the subset, returning the first item of content to the user as a learning supplement for the concept in the learning environment.

### CROSS-REFERENCE TO RELATED APPLICATIONS

This application is a continuation of co-pending U.S. patent application Ser. No. 14/729,993, filed Jun. 3, 2015. The aforementioned related patent application is herein incorporated by reference in its entirety.

### BACKGROUND

The present invention relates to learning aids on computing devices, and more specifically, to dynamic learning supplementation with intelligent delivery of appropriate content.

Educational institutions are increasingly embracing students' use of computers both in and out of the classroom, especially the use of tablets and other small-form computing platforms. Moreover, instead of relying exclusively on a controlled set of instructional materials and applications, educators are increasingly utilizing online sources of information. However, additional solutions are needed to take advantage of cognitive style computing in a classroom environment for improved overall education and learning experiences for students.

### SUMMARY

Embodiments disclosed herein provide systems, methods, and computer program products to perform an operation comprising identifying, in a corpus comprising a plurality of items of content, a subset of the plurality of items of content having a concept matching a concept in a learning environment, wherein each item of content comprises a set of attributes, computing an assistance score for each item of content in the subset based on the set of attributes of the respective item of content in the subset and a set of attributes of a user in the learning environment, and upon determining that a first item of content, of the subset of items of content, has as an assistance score greater than the assistance scores of the other items in the subset, returning the first item of content to the user as a learning supplement for the concept in the learning environment.

### BRIEF DESCRIPTION OF THE SEVERAL VIEWS OF THE DRAWINGS

FIG. 1 illustrates a system which provides dynamic learning supplementation with intelligent delivery of appropriate content, according to one embodiment.

FIG. 2 illustrates a method to provide dynamic learning supplementation with intelligent delivery of appropriate content, according to one embodiment.

FIG. 3 illustrates a method to determine a current concept, according to one embodiment.

FIG. 4 illustrates a method to determine a level of comprehension, according to one embodiment.

FIG. 5 illustrates a method to identify and return supplemental learning materials, according to one embodiment.

### DETAILED DESCRIPTION

Embodiments disclosed herein provide cognitive computing to derive superior benefits from students' access to computing devices, such as laptops, tablets, and the like. More specifically, embodiments disclosed herein deliver a more dynamic, enhanced learning experience through cognitive supplementation and/or lesson augmentation during lectures, learning activities, and extra-curricular engagement. The learning enhancements disclosed herein are individualized to each student, and learns over time how to deliver the most appropriate and valuable enhanced learning experience across all courses of study. Doing so challenges each student regardless of their abilities, and allows each student to achieve beyond what traditional education systems can provide. Generally, embodiments disclosed herein drive students to explore topics at a greater depth in an individualized manner, as students at all levels are challenged to excel further.

Generally, embodiments disclosed herein monitor the lecture feed (using, for example, speech, images or other visual content, lesson plans, and text analysis) to determine a current learning concept. Embodiments disclosed herein may then identify content that is related to the current learning concept, and deliver the content to the students. This supplemental content may be tailored to the particular learning characteristics of the student (such as whether the student is gifted, a visual learner, etc.). Embodiments disclosed herein also monitor student actions, dynamically formulating questions that engage the student and assess their understanding of the topic. If students need more information to solidify their understanding of the topic, embodiments disclosed herein find the best supplemental content, and present the supplemental content in a form that best suits the student's learning profile. In addition, embodiments disclosed herein continue to engage the student until the topic is understood, such as providing additional learning content after school, via email, and the like.

For example, a teacher may be discussing American history during a classroom lecture. Embodiments disclosed herein may listen to the lecture audio in real time to determine when to deliver supplementary content to student computing devices. For example, if embodiments disclosed herein determine that the teacher is covering American history during the time of George Washington, and the teacher mentions the Delaware River. In response, embodiments disclosed herein may display a related image on student computing devices, such as an image of George Washington crossing the Delaware River.

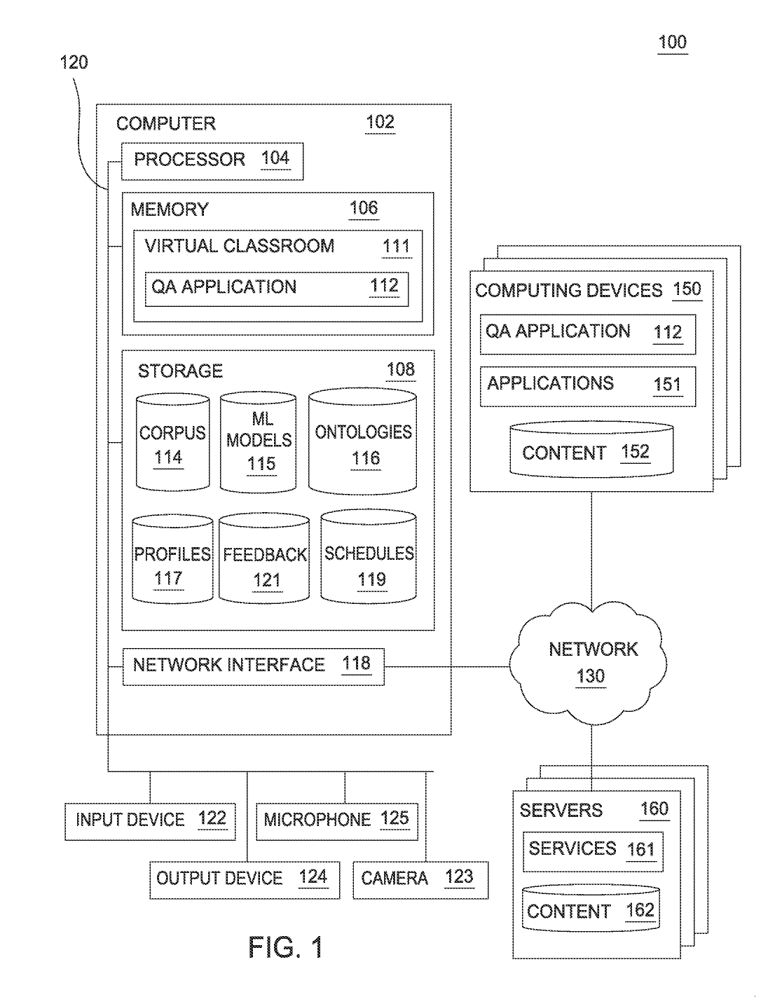

FIG. 1 illustrates a system 100 which provides dynamic learning supplementation with intelligent delivery of appropriate content, according to one embodiment. The system 100 includes a computer 102 connected to other computers via a network 130. In general, the network 130 may be a telecommunications network and/or a wide area network (WAN). In a particular embodiment, the network 130 includes access to the Internet.

The computer 102 generally includes a processor 104 which obtains instructions and data via a bus 120 from a memory 106 and/or storage 108. The computer 102 may also include one or more network interface devices 118, input devices 122, cameras 123, output devices 124, and microphone 125 connected to the bus 120. The computer 102 is generally under the control of an operating system. Examples of operating systems include the UNIX operating system, versions of the Microsoft Windows operating system, and distributions of the Linux operating system. (UNIX is a registered trademark of The Open Group in the United States and other countries. Microsoft and Windows are trademarks of Microsoft Corporation in the United States, other countries, or both. Linux is a registered trademark of Linus Torvalds in the United States, other countries, or both.) More generally, any operating system supporting the functions disclosed herein may be used. The processor 104 is a programmable logic device that performs instruction, logic, and mathematical processing, and may be representative of one or more CPUs. The network interface device 118 may be any type of network communications device allowing the computer 102 to communicate with other computers via the network 130.

The storage 108 is representative of hard-disk drives, solid state drives, flash memory devices, optical media and the like. Generally, the storage 108 stores application programs and data for use by the computer 102. In addition, the memory 106 and the storage 108 may be considered to include memory physically located elsewhere; for example, on another computer coupled to the computer 102 via the bus 120.

The input device 122 may be any device for providing input to the computer 102. For example, a keyboard and/or a mouse may be used. The input device 122 represents a wide variety of input devices, including keyboards, mice, controllers, and so on. The camera 123 may be any image capture device configured to provide image data to the computer 102. The output device 124 may include monitors, touch screen displays, and so on. The microphone 125 is configured to capture and record audio data.

As shown, the memory 106 contains a virtual classroom application 111. The virtual classroom 111 is any application configured to provide a virtual learning environment, such as a chat room or any dedicated suite of online learning tools. The memory 106 also contains a QA application 112, which is an application generally configured to provide a deep question answering (QA) system. One example of a deep question answering system is Watson, by the IBM Corporation of Armonk, N.Y. A user may submit a case (also referred to as a question) to the QA application 112. The QA application 112 will then provide an answer to the case based on an analysis of a corpus of information 114. Although depicted as executing on a single computer, the functionality of the QA application 112 may be provided by grid or cluster of computers (not pictured), and the QA application 112 may serve as a frontend to orchestrate such distributed functionality.

The QA application 112 is trained to generate responses to cases during a training phase. During the training phase, the QA application 112 is trained to answer cases using an “answer key” which predefines the most correct responses. During training, the QA application 112 ingests content in the corpus 114 to produce one or more machine learning models (not pictured). In addition, during the training phase, the QA application 112 is configured to identify data attributes which are important to answering cases (namely, those attributes having an impact on the confidence score of a given answer).

After being trained, the QA application 112 may process user cases through a runtime analysis pipeline. In at least one embodiment, the cases include a current lecture or study topic and a user profile, and the candidate answers returned by the QA application 112 correspond to supplemental learning material that can be returned to the user. The analysis pipeline executes a collection of analysis programs to evaluate both the question text and candidate answers (i.e., text passages extracted from documents in a corpus 114) in order to construct the most probable correct answer, based on the information extracted from the corpus and from the question. A typical execution pipeline may begin with question analysis, which analyzes and annotates each question presented in the case to identify key topics, concepts, and attributes for conducting a search. The next step of the pipeline may include a primary search, which involves searching for documents in the corpus 114 using the key attributes from the question analysis phase. The next step of the pipeline may identify candidate answers. For example, the QA application 112 may identify key matching passages (based on, for example, topics, concepts, and/or string matching) from the search results with passages in the candidate answers. The QA application 112 may then score each candidate answer. In the next step of the pipeline, the QA application 112 may then retrieve supporting evidence for the candidate answers. The QA application 112 may then complete the pipeline by scoring the various candidate answers considering supporting evidence (if such supporting evidence was processed for the candidate answer, as described herein), from which the most correct answer identified by the QA application 112 may returned to the user.

The QA application 112 may be configured to provide dynamic learning supplementation with intelligent delivery of appropriate content. Generally, the QA application 112 may determine a current learning topic (or concept, or context) by analyzing sources of input data available in a current learning environment. For example, in classroom, the QA application 112 may convert speech captured by the microphone 125 to text, and analyze the text to identify one or more topics being discussed by the instructor. Similarly, the QA application 112 may analyze text in a virtual classroom 111 to identify concepts being discussed by an instructor. The QA application 112 may also identify text in an image of a classroom blackboard captured by the camera 125, and analyze the text to determine one or more concepts in the text. Further still, the QA application 112 may analyze documents, applications 151, web searches, or any other content 152 that a user is interacting with on one of the computing devices to determine the current learning topic.

The QA application 112 may also determine, for one or more users of the computing devices 150, the respective user's level of understanding of the learning topic. The QA application 112 may leverage information about the user in a user profile stored in the profiles 117, as well as gather real-time information to determine the user's level of understanding of the topic. For example, the profile 117 may indicate that the user struggles with math and excels at science, providing the QA application 112 with previously acquired data regarding the user. In addition, the QA application 112 may use the camera 123 to capture images of the user's face to detect facial expressions indicating frustration, confusion, or other emotions indicating a level of understanding of the current learning topic. Further still, the QA application 112 may use the microphone 125 to capture audio of a question the user asks about the topic. The QA application 112 may then analyze the question to determine a level of understanding associated with the question (such as whether the question focuses on a basic concept of the learning topic, or a more advanced concept of the learning topic).

For example, if a teacher in a classroom is discussing the American Revolution, the QA application 112 may identify keywords about the concept such as “1776,” “Declaration of Independence,” and the like. The QA application 112 may then reference an ontology 116 to determine that the American Revolution is a current topic (or concept) of the lecture. The QA application 112 may then identify, from the corpus 114, one or more items of content that may serve as learning supplements for the discussion related to the American Revolution. The QA application 112 may focus on items in the corpus 114 having attributes that match attributes of a given user. For example, the QA application 112 may ensure that the content in the corpus 114 is of a reading level that matches the reading level of the respective user. Generally, the QA application 112 may score each identified item of content in the corpus 114 using a machine learning model 115. The output of the ML model 115 may be a score reflecting a suitability of a given item of content from the corpus 114 relative to a given user. The QA application 112 may then return one or more items of content having the highest suitability score for each user.

For example, if the profile 117 of student X indicates that student X has a high level of understanding of the American Revolution and an interest in studying law, the QA application 112 may return, user X's computing device 150, a copy of the Declaration of Independence. Similarly, student Y's profile 117 may specify that student Y is a visual learner. The QA application 112, may analyze student Y's questions about the American Revolution to determine that student Y is struggling with the core disputes that triggered the Revolution, the QA application 112 may return an image which highlights the main dispute that caused the Revolution, such as taxation without representation, and the like. In addition, the QA application 112 may follow up with the students after presenting supplemental learning material. The QA application 112 may, for example, email the students with additional learning material, quizzes, and the like, to challenge the student to learn more about the subject. The QA application 112 may also monitor the user's progress in learning or understanding the topic to tailor subsequent learning supplements based on the user's most current level of understanding of the topic.

As shown, the storage 108 includes a corpus 114, machine learning models 115, ontologies 116, profiles 117, schedules 119, and feedback 121. The corpus 114 is a body of information used by the QA application 112 to generate answers to questions (also referred to as cases). For example, the corpus 114 may contain scholarly articles, dictionary definitions, encyclopedia references, product descriptions, web pages, and the like. The machine learning (ML) models 115 are models created by the QA application 112 during a training phase, which are used during the execution pipeline to score and rank candidate answers to cases based on features (or attributes) specified during the training phase. For example, a ML model 115 may score supplemental learning content identified in the corpus 114 based on how well the supplemental learning content matches the current learning topic, the user's level of understanding of the learning topic, the user's reading level, the user's preferred method of learning (such as being a visual learner, audio learner, and the like), the format of the supplemental learning content, feedback related to the supplemental learning content stored in the feedback 121, and the like.

The ontologies 116 include one or more ontologies providing a structural framework for organizing information. An ontology formally represents knowledge as a set of concepts within a domain, and the relationships between those concepts. Profiles 117 include information related to different users. The user profiles in the profiles 117 may include any information about the users, including biographical information, education level, profession, reading level, preferred learning techniques, levels of understanding of a plurality of learning subjects, and the like. The schedules 119 may include data specifying lesson plans, lecture topics, business agendas, and the like. For example, a teacher may create a day's lesson plan that specifies which topics will be taught at which times during the day (such as Greek mythology being taught from 9:00-10:00 AM). In at least one embodiment, the QA application 112 may leverage the schedules 119 when determining the current context (or topic of discussion). The QA application 112 may also ingest a schedule 119 prior to a lecture to provide teachers suggested content for inclusion or exclusion from the lecture. Similarly, the QA application 112 may use the schedules 119 to dynamically generate content for students to review prior to a lecture. The feedback 121 includes feedback from different users related to content in the corpus 114 returned as supplemental learning content. For example, students and teachers may provide feedback indicate whether a video about the Pythagorean Theorem was an effective learning supplement. Doing so may allow the QA application 112 to determine whether or not to provide the video as a learning supplement to other students in the future.

As shown, the networked system 100 includes a plurality of computing devices 150. The computing devices 150 may be any type of computing device, including, without limitation, laptop computers, desktop computers, tablet computers, smartphones, portable media players, portable gaming devices, and the like. As shown, the computing devices 150 include an instance of the QA application 112, applications 151, content 152 on the computing devices 150. The applications 151 may include any application or service, such as word processors, web browsers, e-reading applications, video games, productivity software, business software, educational software, and the like. The content 152 may be any locally stored content, such as documents, media files, and the like. The instance of the QA application 112 executing on the computing devices 150 may interface with the instance of the QA application 112 executing on the computer 102 to provide supplemental learning content (from the corpus 114, the servers 160, or any other source) to users of the computing devices 150.

As shown, remote servers 160 provide services 161 and content 162 to the computing devices 150. The services 161 may include any computing service, such as search engines, online applications, and the like. The content 162 may be any content, such as web pages (e.g., an online encyclopedia), media, and the like. The QA application 112 may provide services from the services 161 and/or content 162 to the users computing devices 150 as learning supplements.

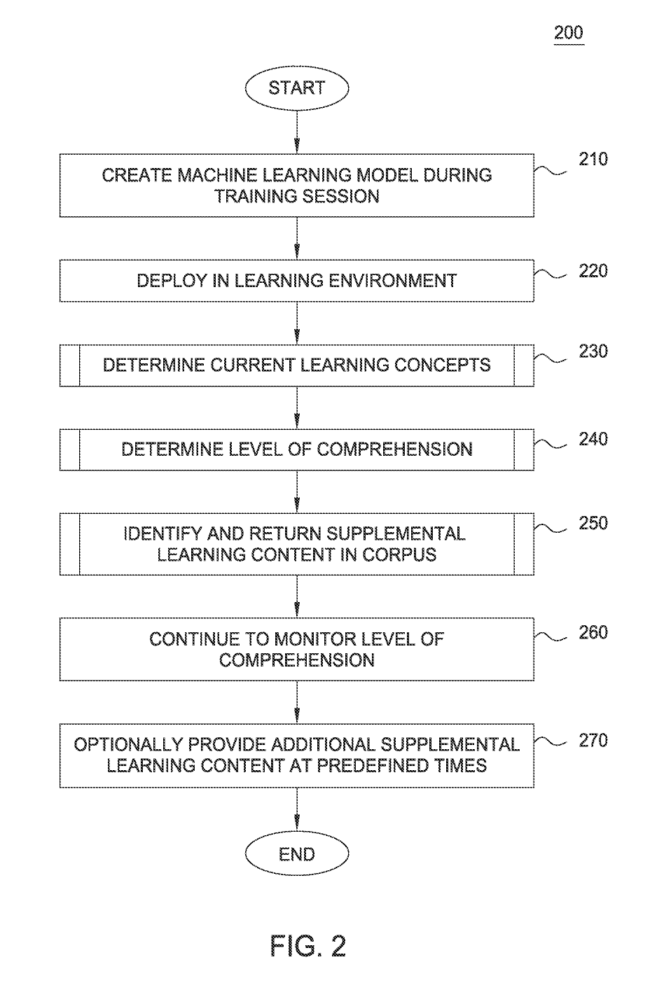

FIG. 2 illustrates a method 200 to provide dynamic learning supplementation with intelligent delivery of appropriate content, according to one embodiment. Generally, the QA application 112 may execute the steps of the method 200 to provide cognitive supplementation and lesson augmentation during, for example, classroom lectures, learning activities, and after-school engagement. The QA application 112 may individualize the supplemental content to each student while learning over time how to deliver the most appropriate and valuable enhanced learning experience in specific classroom.

As shown, the method 200 begins at step 210, where a machine learning (ML) model is created and stored in the ML models 115 during a training phase of the QA application 112. The ML model may specify different attributes, or features, that are relevant in scoring a piece of content from the corpus 114 as being a suitable learning supplement for a given user (or users). For example, the features may include reading levels (of users and content), levels of sophistication of content in the corpus 114, a format of the content, an instruction type of each item of content, feedback reflecting a level of effectiveness of each an item of content, a learning classification of the user, a preferred learning format of the user, a preferred instruction type of the user, and the like.

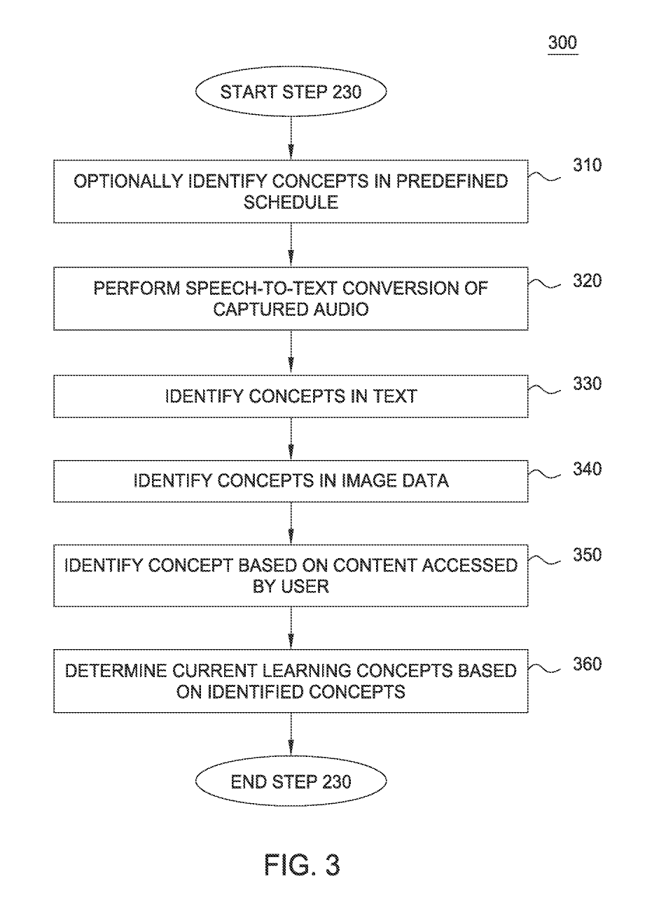

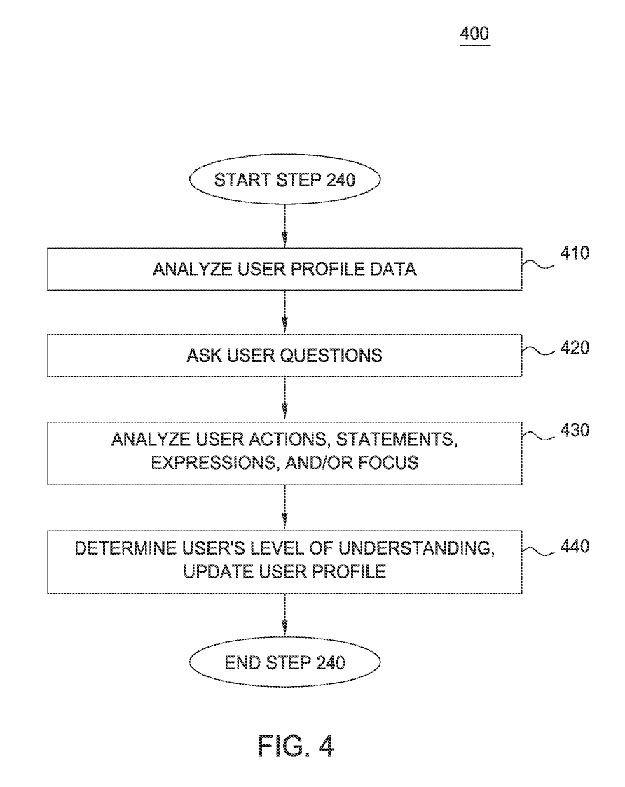

At step 220, the QA application 112 may be deployed on a computing system in a learning environment. For example, the QA application 112 may be deployed on the computer 102 serving as a central controller in a classroom where students use a computing device 150 executing the QA application 112. At step 230, described in greater detail with reference to FIG. 3, the QA application 112 may determine the current learning concepts (or topics). For example, during a classroom lecture, the QA application 112 may identify an image of an integral presented to students and analyze the instructor's speech to determine that the current topic is calculus. At step 240, described in greater detail with reference to FIG. 4, the QA application 112 may determine, for one or more users, a respective level of comprehension (or understanding) of the current learning topic. For example, the QA application 112 may determine from the profiles 117 that a student who consistently receives A's in mathematics courses has a high level of comprehension of calculus. Similarly, a different student profile 117 may indicate that another student consistently receives D's in mathematics courses may have a low level of comprehension (or understanding) of calculus.

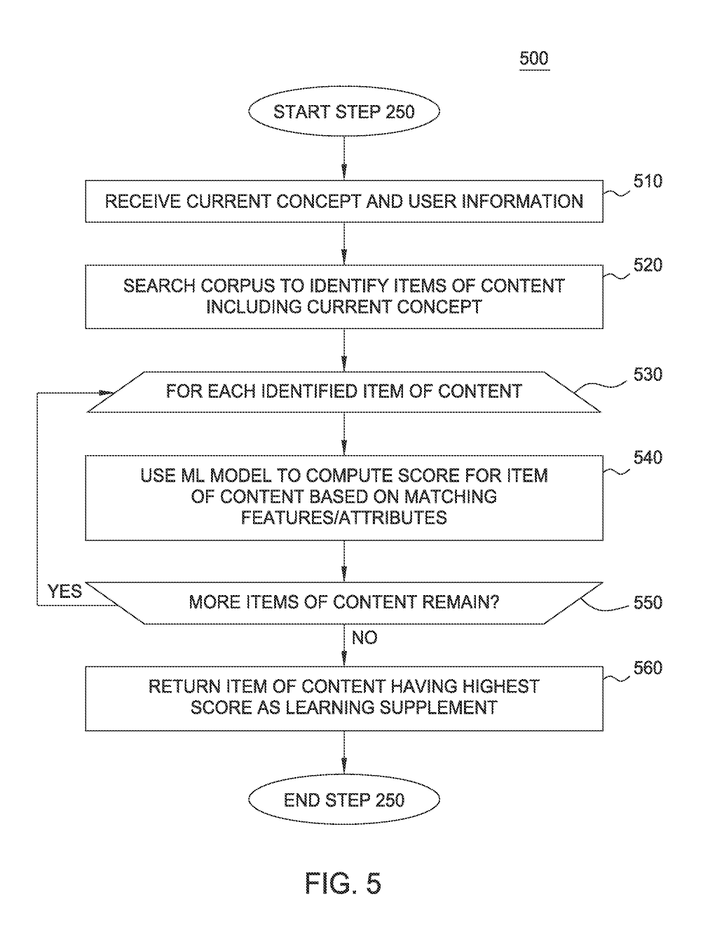

At step 250, described in greater detail with reference to FIG. 5, the QA application 112 may identify content from the corpus 114 and return the content to the user as a learning supplement. Generally, the QA application 112 may be configured to receive the current learning topic and the user's profile 117 as the “case” or “question.” The QA application 112 may then identify content in the corpus 114 matching the topic (and or one or more high-level filters based on the profile). The QA application 112 may then score the identified content using the ML model 115. The output of the ML model 115 may be a score for each item of content, reflecting a level of suitability for the content relative to the user's attributes. The QA application 112 may then return the item of content from the corpus 114 having the highest score to the user as a learning supplement. For example, the QA application 112 may return an animated graphic of what an integral is to a visual learner struggling with integrals, while returning an audio book on triple integrals to an advanced mathematics student who is comfortable with single integrals and is an audio learner. At step 260, the QA application 112 may continue to monitor user comprehension of the learning topic. At step 270, the QA application 112 may provide additional supplemental learning content at predefined times (such as during a lecture, after a lecture, at nights, on weekends, and the like). For example, the QA application 112 may send a dynamically generated set of additional learning content at the end of a lecture to the user via email. As another example, the QA application 112 may re-engage lost, bored, or struggling students by providing supplemental learning content during a lecture, which may cause the student to actively participate in the lecture.

FIG. 3 illustrates a method 300 corresponding to step 230 to determine a current learning concept, according to one embodiment. In at least one embodiment, the QA application 112 performs the steps of the method 300. The method 300 begins at step 310, where the QA application 112 may optionally identify concepts specified in a predefined schedule of concepts in the schedules 119. For example, a teacher may specify daily schedules indicating which subjects will be taught at what times. The QA application 112 may use these schedules to supplement natural language processing performed on any captured text, speech, images, and the like. At step 320, the QA application 112 may convert speech captured by the microphone 125 to text. At step 330, the QA application 112 may identify concepts in text. The text may be the output of the converted speech at step 320, or may be text captured by the QA application 112 from different sources, such as the virtual classroom application 111. At step 340, the QA application 112 may identify concepts in image data. The image data may include images and/or text that the QA application 112 may analyze to identify concepts. At step 350, the QA application 112 may identify a concept based on content accessed by a user on their respective computing device 150. For example, the QA application 112 may identify open applications 151, web searches, and the like. The QA application 112 may also leverage this information to determine a user's level of engagement with a current lecture. At step 360, the QA application 112 may determine the current learning concept based on the concepts identified at step 310-350. Therefore, for example, if the QA application 112 determines that a lesson plan in the schedules 119 indicates a geometry lesson is scheduled for 2:00-3:00 PM, that the instructor is talking about the angles of a triangle, and identifies triangles and other geometric objects drawn on a blackboard, the QA application 112 may determine that geometry is the current subject (or concept). Doing so may allow the QA application 112 to return geometry related supplemental learning content to the computing devices 150. The QA application 112 may perform the steps of the method 300 continuously, or according to a predefined timing schedule to ensure that the most current learning concept is detected.

FIG. 4 illustrates a method 400 corresponding to step 240 to determine a level of comprehension, according to one embodiment. Generally, the QA application 112 may perform the steps of the method 400 to determine the user's level of understanding of (or comprehension, familiarity, comfort, etc) a given learning topic. The QA application 112 may perform the steps of the method 400 for any number of users. As shown, the method 400 begins at step 410, where the QA application 112 may analyze user data in the profiles 117. The profiles may specify learning strengths, weaknesses, preferences, and the like. At step 420, the QA application 112 may ask the user questions to gauge their level of understanding. The QA application 112 may leverage the number of correct or incorrect answers the user provides to determine the user's level of understanding of a given topic. At step 430, the QA application 112 may analyze one or more of user actions, statements, expressions, or focus. For example, the QA application 112 may identify questions, facial expressions, gestures, or statements indicating frustration or lack of understanding during a lecture. Similarly, if a student asks advanced questions during an introductory lecture on a topic, the QA application 112 may determine that the user has a level of understanding that exceeds the introductory material. At step 440, the QA application 112 may determine the user's level of understanding based on the determinations made at steps 410-430. The QA application 112 may also update the user's profile in the profiles 117 to reflect the most current level of understanding of the current learning topic.

FIG. 5 illustrates a method 500 corresponding to step 250 to identify and return supplemental learning materials, according to one embodiment. The method 500 begins at step 510, where the QA application 112 receives the current learning concept and user information (such as data from the user's profile 117 and information about the user's level of understanding of the current learning concept determined via the method 400). At step 520, the QA application 112 may search the corpus 114 to identify items of content including the current learning concept. The QA application 112 may reference concept annotations of items of content the corpus 114, or may perform natural language processing on the content to determine whether the content includes a matching concept. For example, if the current lecture concept is P orbitals in chemistry, the QA application 112 may identify articles, videos, and images in the corpus 114 which discuss P orbitals of atoms. At step 530, the QA application 112 may execute a loop including step 540 for each item of content identified at step 520. At step 540, the QA application 112 may apply a machine learning (ML) model from the ML models 115 to compute a score for the current item of content. The score may be a suitability score reflecting how suitable the content would serve as a learning tool for the current user. The ML model may compute the score based on how well the attributes of the user match the attributes of the content, as well as feedback from the feedback 120 related to the item of content. For example, if the user is an expert in psychology, and the current item of content is a part of an introductory lesson in psychology, the ML model would output a score indicating a low suitability level for the expert. As another example, if feedback from users and teachers in the feedback 121 indicates that a video on algebra is beneficial for users struggling with algebra, and the current student is determined to be struggling with algebra, the ML model may output a score reflecting a high level of suitability to return the video on algebra to the student as a learning tool. At step 550, the QA application 112 determines whether more items of content remain. If more items of content remain, the QA application 112 returns to step 530. If no more items of content remain, the QA application 112 proceeds to 560, where the QA application 112 may return the item of content having the highest score as a learning supplement.

Advantageously, embodiments disclosed herein dynamically return supplemental learning content to all types of users. Embodiments disclosed herein may monitor a current learning environment (such as a physical classroom, virtual classroom, or a user's computer) to determine a current learning concept. Doing so may allow embodiments disclosed herein to identify related topics for which content can be returned to the student as a supplemental learning tool. Embodiments disclosed herein monitor user actions, dynamically formulating questions that quickly assess the user's understanding of the learning topic. If the user needs more information to solidify their understanding, embodiments disclosed herein find the best content to do so, and return the content that is in a format that best suits the student's learning profile (such as visual items for visual learners). Embodiments disclosed herein may return the supplemental content immediately, or postponed and sent at a later time via email or some other mechanism). In addition, embodiments disclosed herein may continue to engage users, even outside of the classroom, until the user understands the topic. For example, embodiments disclosed herein may prompt the student to set aside a time to engage in further supplemental learning. Further still, embodiments disclosed herein determine the user's state—such as whether the user is interested or confused, to ensure that students remain engaged.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the foregoing, reference is made to embodiments presented in this disclosure. However, the scope of the present disclosure is not limited to specific described embodiments. Instead, any combination of the recited features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the recited aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications or related data available in the cloud. For example, the QA application 112 could execute on a computing system in the cloud and dynamically identify individualized learning content for users. In such a case, the QA application 112 could store the identified learning content at a storage location in the cloud. Doing so allows a user to access this information from any computing system attached to a network connected to the cloud (e.g., the Internet).

While the foregoing is directed to embodiments of the present invention, other and further embodiments of the invention may be devised without departing from the basic scope thereof, and the scope thereof is determined by the claims that follow.

What is claimed is:

1. A method, comprising:
identifying, in a corpus comprising a plurality of items of content, a subset of the plurality of items of content having a concept matching a concept in a learning environment, wherein each item of content comprises a respective set of attributes;
computing an assistance score for each item of content in the subset based on the respective set of attributes of the item of content in the subset and a set of attributes of a user in the learning environment; and
upon determining that a first item of content, of the subset of items of content, has as an assistance score greater than the assistance scores of the other items in the subset, returning the first item of content to the user as a learning supplement for the concept in the learning environment.

2. The method of claim 1, wherein the set of attributes of the items of content comprise one or more of: (i) a reading level of each item of content, (ii) a format of each item of content, (iii) an instruction type of each item of content, and (iv) feedback reflecting a level of instruction effectiveness of each item of content.

3. The method of claim 1, wherein the set of attributes of the user comprise one or more of: (i) a reading level of the user, (ii) a learning classification of the user, (iii) a level of understanding of the user relative to the concept in the learning environment, (iv) a preferred learning format of the user, and (v) a preferred instruction type of the user.

4. The method of claim 1, wherein the assistance score of each item is computed based on a machine learning model receiving the set of attributes of the user and the set of attributes of the content as input, wherein the first item of content is returned at a first time, the method further comprising:
returning, at a second time, subsequent to the first time, at least one of: (i) the first item of content (ii) and a second item of content from the subset.

5. The method of claim 1, further comprising:
determining the concept in the learning environment based on one or more of: (i) analysis of an audio recording of the learning environment, (ii) a lecture plan, (iii) analysis of an image displayed in the learning environment, (iv) analysis of content presented in an application executing on a system of the user, and (v) a search query entered by the user.

6. The method of claim 1, further comprising:
subsequent to returning the first item of content, monitoring a set of actions of the user;
determining, based on the set of actions of the user, whether the first item of content assisted the user;
storing an indication as to whether the first item of content assisted the user; and
upon determining that the first item of content did not assist the user, returning a second item of content from the subset to the user.

7. The method of claim 6, wherein the set of actions comprise: (i) facial expressions, (ii) speaking, (iii) interacting with the first item of content, (iv) and searches performed by the user.
